(19) United States
(12) Patent Application Publication
(10) Pub. No.: US 2025/0010292 A1
(43) Pub. Date: Jan. 9, 2025

(54) MICROFLUIDIC DEVICE AND MICROPARTICLE MEASUREMENT SYSTEM

(71) Applicant: ADVANTEST CORPORATION, Tokyo (JP)

(72) Inventors: Nobuei WASHIZU, Tokyo (JP); Takeaki TAKADA, Tokyo (JP); Hoshito TAGUCHI, Tokyo (JP); Kosuke OINUMA, Tokyo (JP); Hitomi MANIWA, Tokyo (JP)

(21) Appl. No.: 18/757,669

(22) Filed: Jun. 28, 2024

(30) Foreign Application Priority Data
Jul. 3, 2023 (JP) 2023-109531

(51) Int. Cl. B01L 3/00

(52) U.S. Cl. CPC B01L 3/502715; B01L 3/502761; B01L 2200/027; B01L 2200/10; B01L 2300/0816; B01L 2300/0861; B01L 2300/123

(57) ABSTRACT

A microfluidic device has a microfluidic chip. The microfluidic chip has a channel formed in an in-plane direction thereof. The microchannel has a gate with a narrowed width, and a first part and a second part separated by the gate. With the length of the gate denoted as L, and with the width of the gate denoted as W, a relational expression 1≤L/W<2 is satisfied.

### REFERENCE TO RELATED APPLICATIONS

The present invention claims priority under 35 U.S.C. § 119 to Japanese Patent Application No. 2023-109531 filed on Jul. 3, 2023, the entire contents of which is incorporated herein by reference.

### BACKGROUND

### 1. Technical Field

The present disclosure relates to a microfluidic device.

### 2. Background Information

Method for measuring particle size distribution called electrical sensing zone method (Coulter's principle) has been known. In this measurement method, an electrolytic solution that contains a particle is allowed to pass through a pore called nanopore. During passage of the particle, the pore will have therein the electrolytic solution whose amount is reduced by the volume of the particle and will increase the electric resistance. The volume (or, particle size) of the particle can therefore be determined by measuring the electric resistance of the pore.

FIG. 1 is a block diagram illustrating a microparticle measurement system 1R making use of the electrical sensing zone method. The microparticle measurement system 1R has a pore device 100R, a measuring instrument 200R, and a data processor 300.

The inside of the pore device 100R is filled with an electrolytic solution 2 that contains particles 4 to be detected. The inside of the pore device 100R is partitioned with a pore chip 102 into two spaces, in which an electrode 106 and an electrode 108 are individually provided. The pore chip 102 has a pore 104 formed therein. Under potential difference generated between the electrode 106 and the electrode 108, an ion current flows between the electrodes, during which the particles 4 migrate from one space through the pore 104 into the other space while driven by electrophoresis.

The measuring instrument 200R generates a potential difference between a pair of electrodes 106, 108, and acquires information correlated with the resistivity Rp between the electrode pair. The measuring instrument 200R has a transimpedance amplifier 210, a voltage source 220, and a digitizer 230. The voltage source 220 is structured to generate a potential difference Vb between the pair of electrodes 106, 108. The potential difference Vb provides a driving force of electrophoresis, and gives a bias signal for measuring the resistivity Rp.

Between the pair of electrodes 106, 108, there flows microcurrent Is which is inversely proportional to the resistivity of the pore 104.

$$Is = Vb / Rp \qquad ( 1 )$$

The transimpedance amplifier 210 converts the microcurrent Is into voltage signal Vs. With the conversion gain denoted as r, the equation below holds.

$$Vs = - r \times Is \qquad ( 2 )$$

Substitution of equation (1) into the equation (2) gives equation (3) below.

$$Vs = - Vb \times r / Rp \qquad ( 3 )$$

The digitizer 230 converts the voltage signal Vs into digital data Ds. As can be seen, the voltage signal Vs inversely proportional to the resistivity Rp of the pore 104 is obtainable, with use of the measuring instrument 200R.

FIG. 2 is an exemplary waveform chart of the microcurrent Is measured with the measuring instrument 200R. Note that the ordinates and abscissae of the waveform charts or time charts referred to herein are appropriately enlarged or shrunk for easy understanding, and also the waveforms illustrated herein are simplified, exaggerated or emphasized for easy understanding.

For a short period of passage of the particles, the resistivity Rp of the pore 104 increases. The current Is therefore decreases like in a pulsated manner, every time one particle passes. The amplitude of each pulse current correlates with the particle size. The data processor 300 processes the digital data Ds, and typically analyzes the count or particle size of the particles 4 contained in the electrolytic solution 2. A part of the data processor 300 may be placed in a server or a cloud.

The prior pore chip 102 is structured to have an opening (pore) formed in a membrane, with the thickness t considerably smaller than the diameter (aperture) d of the pore (t<d). The present disclosers have studied such low-aspect-ratio pore device, and have recognized problems below.

In the low-aspect-ratio pore device, electric field intensity in the pore demonstrates a large positional dependence in the radial direction. Different signals will therefore be observable between the cases whether the particle passes the center of the pore, or the outer periphery of the pore, thereby degrading measurement accuracy.

### SUMMARY

The present disclosure has been arrived at considering such circumstances, so that one exemplary embodiment thereof is to provide a device whose measurement accuracy may be improved.

A microfluidic device in one embodiment of the present disclosure has a microfluidic chip. The microfluidic chip has a channel formed in an in-plane direction thereof. The channel has a gate with a narrowed width, and a first part and a second part separated by the gate. With the length of the gate denoted as L, and with the width of the gate denoted as W, a relational expression 1≤L/W<2 is satisfied.

Note that also free combinations of these constituents, and also any of the constituents and expressions exchanged among the method, apparatus, and system, are valid as the present disclosure or modes of the present disclosure. Also note that the description of this section (SUMMARY OF THE INVENTION) does not describe all essential features of the present disclosure, and thus also subcombinations of these features described herein may constitute the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram illustrating a microparticle measurement system making use of the electrical sensing zone method,

FIG. 2 is an exemplary waveform chart of microcurrent measured with the measuring instrument,

FIG. 3 is a cross-sectional view illustrating a prior pore chip,

FIG. 4 is a diagram illustrating a histogram generated from measurement of a standard particle with use of the prior pore chip,

FIG. 5 is a schematic drawing explaining a cause of splitting of the histogram in the prior art,

FIG. 6 is a perspective view illustrating a microfluidic device according to First Embodiment,

FIG. 7A is a plan view illustrating a microfluidic device,

FIG. 7B is a cross-sectional view illustrating the microfluidic device in FIG. 7A taken along line A-A′,

FIG. 8 is an enlarged view illustrating a gate and the surrounding of the microfluidic chip,

FIG. 9 is a drawing illustrating a microparticle measurement system having the microfluidic device,

FIG. 10 is a chart illustrating potential at the gate and the surrounding of the microfluidic device,

FIG. 11 is a chart illustrating an electric field at the gate and the surrounding of the microfluidic device,

FIG. 12 is a chart illustrating an electric field distribution of a microfluidic chip having sizes of W=H=L=3 μm,

FIG. 13 is a chart illustrating an electric field distribution of a microfluidic chip having sizes of W=H=3 μm, and L=50 nm,

FIG. 14 is a chart illustrating aspect ratio dependence of the electric field intensity distribution in the y-direction,

FIG. 15 is a cross-sectional view illustrating a microfluidic device of Modified Example 1,

FIG. 16 is a perspective view illustrating a microfluidic device according to Modified Example 2,

FIG. 17A is a plan view illustrating the microfluidic device in FIG. 16;

FIG. 17B is a cross-sectional view illustrating the microfluidic device in FIG. 17A taken along line A-A′,

FIG. 18 is an enlarged view illustrating a gate and the surrounding of a microfluidic chip according to Modified Example 3,

FIG. 19 is a cross-sectional view illustrating a microfluidic device according to Modified Example 4,

FIG. 20 is a plan view illustrating a microfluidic device according to Second Embodiment,

FIG. 21 is a plan view illustrating the microfluidic device in FIG. 20; and

FIG. 22 contains a plan view illustrating the microfluidic device in FIG. 21, and a cross-sectional view taken along line A-A′.

### DETAILED DESCRIPTION

### Outline of Embodiments

Some exemplary embodiments of the present disclosure will be outlined. This outline is intended for briefing some concepts of one or more embodiments, for the purpose of basic understanding of the embodiments, as an introduction before detailed description that follows, without limiting the scope of the invention or disclosure. This outline is not an extensive overview of all possible embodiments and is therefore intended neither to specify key elements of all embodiments, nor to delineate the scope of some or all of the embodiments. For convenience, the term “one embodiment” may be used to designate a single embodiment (example or modified example), or a plurality of embodiments (Examples or Modified Examples) disclosed in the present specification.

The microfluidic device according to one embodiment has a microfluidic chip. The microfluidic chip has a channel formed in an in-plane direction thereof. The channel has a gate with a narrowed width, and a first part and a second part separated by the gate. With the length of the gate denoted as L, and with the width of the gate denoted as W, a relational expression 1≤L/W<2 is satisfied.

This structure can generate, in the gate, an electric field which is substantially uniform in the width and height directions. The structure can generate electric signals at the same intensity upon passage of every particle thorough the gate, regardless of the route of passage, and can therefore improve the measurement accuracy.

In one embodiment, a cross-sectional shape of the gate may be rectangular.

In one embodiment, the cross-section of the gate may have the width and the length which are substantially equal.

In one embodiment, the microfluidic chip may be formed of polydimethylsiloxane. The polydimethylsiloxane has an advantage over other materials, in terms of workability and cost. The microfluidic chip may alternatively be formed of a cyclic olefin-based resin such as COP (cyclic olefin polymer) or COC (cyclic olefin copolymer).

In one embodiment, the microfluidic chip may have an inflow port (inlet) structured to communicate the outside of the microfluidic chip with the first part; and an outflow port (outlet) structured to communicate the outside of the microfluidic chip with the second part.

In one embodiment, the microfluidic chip may have a first inflow port structured to communicate the outside of the microfluidic chip with the first part; a second inflow port structured to communicate the outside of the microfluidic chip with the second part; a first outflow port structured to communicate the outside of the microfluidic chip with the first part; and a second outflow port structured to communicate the outside of the microfluidic chip with the second part.

The microfluidic chip may further have a first electrode opening structured to communicate a bottom face of the microfluidic chip with the first part; and
a second electrode opening structured to communicate a bottom face of the microfluidic chip with the second part. The microfluidic device may further have an electrode sheet having the microfluidic chip stacked on a surface thereof. The electrode sheet may have, formed on a surface thereof, a first electrode drawn out through the first electrode opening, and a second electrode drawn out through the second electrode opening.

A microparticle measurement system according to one embodiment may have any one of the aforementioned microfluidic devices; and a measuring instrument connected to the microfluidic device and structured to measure an electric signal.

### EMBODIMENTS

Preferred embodiments will be explained below, referring to the attached drawings. All similar or equivalent constituents, members and processes illustrated in the individual drawings will be given same reference signs, so as to properly avoid redundant explanations. The embodiments are merely illustrative and are not restrictive about the disclosure or the invention. All features and combinations thereof described in the embodiments are not always necessarily essential to the disclosure or the invention.

Dimensions (thickness, length, width, etc.) of the individual members illustrated in the drawings may be appropriately enlarged or shrunk for easy understanding. Furthermore, the dimensions of the plurality of members do not necessarily indicate the dimensional relationship among them, so that a certain member A, if depicted thicker than another member B in a drawing, may even be thinner than the member B.

In the present specification, a “state in which a member A is coupled to a member B” includes a case where the member A and the member B are physically and directly coupled, and a case where the member A and the member B are indirectly coupled while placing in between some other member that does not substantially affect the electrically coupled state, or does not degrade the function or effect demonstrated by the coupling thereof.

Similarly, a “state in which a member C is provided between the member A and the member B” includes a case where the member A and the member C, or the member B and the member C are directly coupled, and a case where they are indirectly coupled, while placing in between some other member that does not substantially affect the electrically coupled state among the members, or does not degrade the function or effect demonstrated by the members.

In the present specification, reference signs attached to electric signals such as voltage signal and current signal, or circuit elements such as resistor, capacitor, and inductor represent voltage value, current value, or circuit constants (resistivity, capacitance, and inductance) of the individual components as necessary.

Prior to describing a microfluidic device 400 according to an embodiment, a prior pore chip and relevant problems thereof will be described.

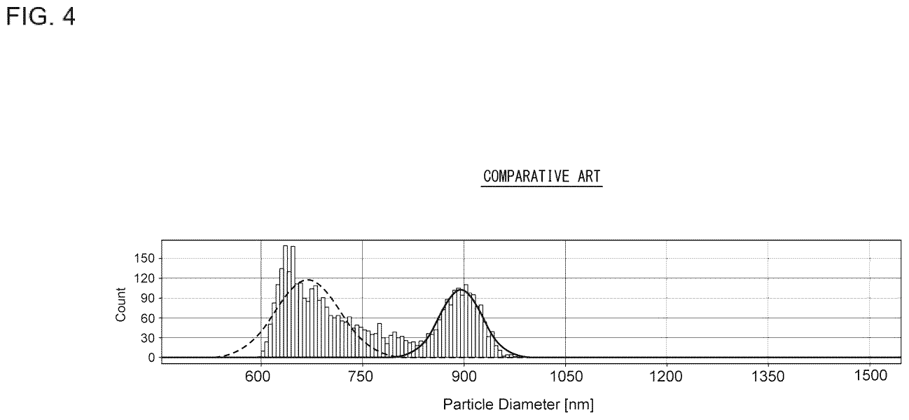

FIG. 3 is a cross-sectional view illustrating a prior pore chip 800. The pore chip 800 has a membrane 810, and the membrane 810 has a pore (opening) 812 formed therein. The prior pore chip 800 has employed the membrane 810 having a thickness t of several tens nanometers. This is because (i) the membrane will have high crystallinity and will be formed within a short time by reducing the thickness t, (ii) the thin membrane will be more accessible due to its lower cost and shorter delivery time, and (iii) the thin membrane will have better workability typically in post-processes such as dry etching.

With use of such membrane 810 having a thickness t of several tens nanometers, a relational expression between the diameter d of the pore 812 (referred to as pore diameter) and the thickness t of the membrane 810 will be given by:

d>t. Defining now the aspect ratio of the pore as t/d, the prior pore chip 800 is understood to have a low aspect ratio.

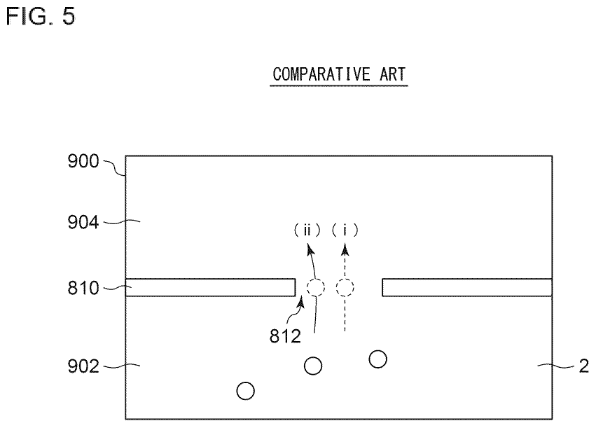

FIG. 4 is a diagram illustrating a histogram generated from measurement of a standard particle with use of a prior pore chip 800. The pore chip 800 used in the experiment has d=3 μm, and an aspect ratio of 0.017 (t=0.050 μm). The standard particle has a diameter of 0.9 μm. The abscissa of the histogram plots the particle size estimated from the electric current measured upon passage of the particle through the pore, and the ordinate plots the count of the particles.

Although the histogram should ideally be unimodal since the standard particle has a uniform diameter, the measured results demonstrated two split peaks, indicating strong bimodality. The bimodality of the histogram makes estimation of the particle size difficult and degrades the measurement accuracy.

The present disclosers has focused on the electric field strength in the pore 812, as a possible reason for the bimodality found with use of the prior pore chip 800.

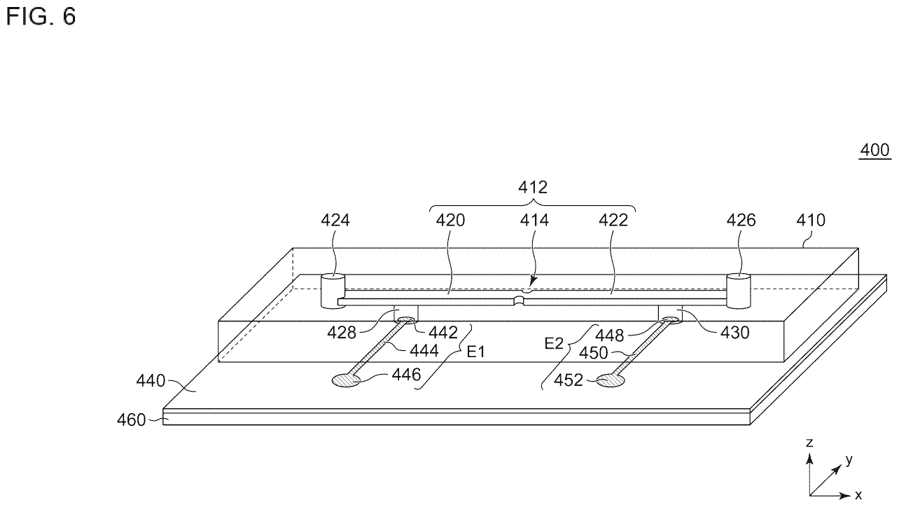

FIG. 5 is a schematic drawing explaining a cause of splitting of the histogram in the prior art. The pore chip 800 is enclosed in a case 900. The case 900 is partitioned into two chambers 902, 904 by the pore chip 800. The chambers 902, 904 are filled with the electrolytic solution 2 that contains the particles 4. The particles 4 can take different routes as they pass through the pore 812. FIG. 5 illustrates two representative routes (i) and (ii). If the electric field intensity in the pore 812 is uniform, measured signals shall have the same intensity regardless of the route of passage. On the other hand, if the electric field intensity in the pore 812 is not uniform, the measured signals would demonstrate different intensities depending on the route of passage, even if the particles 4 have a uniform size. This has caused the splitting of the histogram.

The problem in the prior art has been described. Paragraphs below will explain a microfluidic device 400 according to embodiments capable of solving the problem.

### First Embodiment

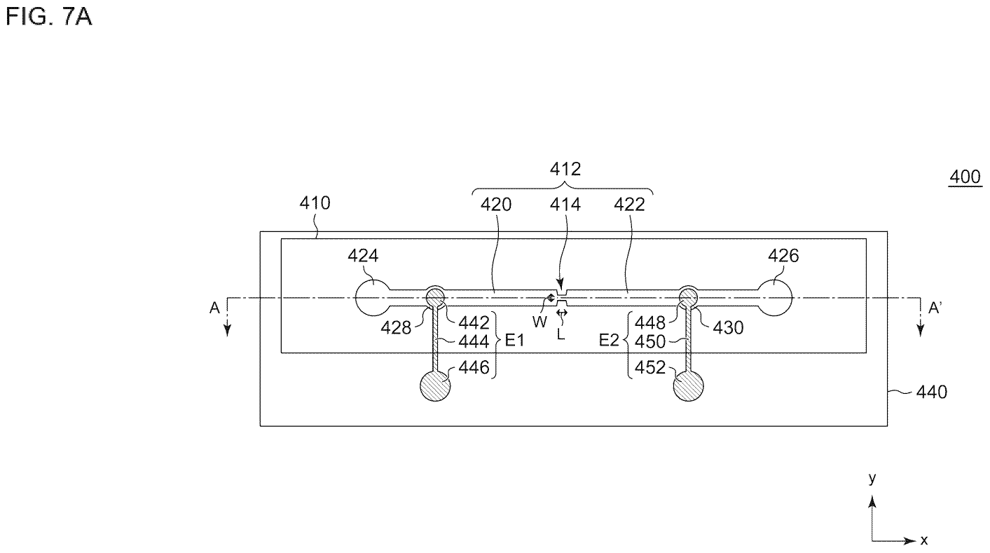

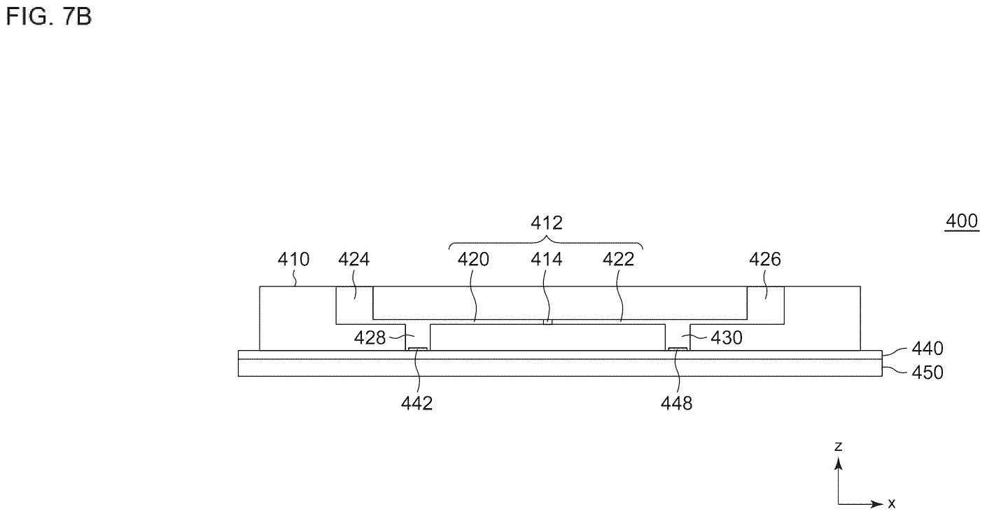

FIG. 6 is a perspective view illustrating a microfluidic device 400 according to First Embodiment. FIG. 7A is a plan view illustrating the microfluidic device 400. FIG. 7B is a cross-sectional view of the microfluidic device 400 in FIG. 7A, taken along line A-A′.

The microfluidic device 400 has stacked therein a microfluidic chip 410, an electrode sheet 440, and a support substrate 460. The microfluidic chip 410 has a microchannel 412 formed in-plane (in the x-y plane). Although the microchannel 412 possibly has a so-called micrometer order size (a channel width of several to several hundreds micrometers), the width at the gate thereof may locally have a submicron or nanometer order size, since the width is designed in consideration of the particles to be measured, as described later.

The microfluidic chip 410 may be formed of polydimethylsiloxane. The microfluidic chip 410 may alternatively be formed of a cyclic olefin-based resin such as COP (cyclic olefin polymer) or COC (cyclic olefin copolymer). Method for forming the microchannel 412 may rely upon any technique having been known or would be available for the future, without special limitation.

The microchannel 412 extends in the x-direction, with one end connected to an inlet 424, and with the other end connected to an outlet 426. One of the inlet 424 and the outlet 426 may be used as an inflow port of the electrolytic solution that contains the microparticles, and the other may be used as an air vent.

The inlet 424 communicates the first space 420 with the upper face of the microfluidic chip 410, meanwhile the outlet 426 communicates the second space 422 with the upper face of the microfluidic chip 410.

The first electrode opening 428 communicates the first space 420 with the bottom face of the microfluidic chip 410. The second electrode opening 430 communicates the second space 422 with the bottom face of the microfluidic chip 410.

The electrode sheet 440 has a first electrode E1 and a second electrode E2 formed thereon. The first electrode E1 is drawn out through the first electrode opening 428 outwards, meanwhile the second electrode E2 is drawn out through the second electrode opening 430 outwards.

The first electrode E1 has a first channel-side electrode 442, a first interconnect 444, and a first measuring instrument-side electrode 446. The first measuring instrument-side electrode 446 is formed at a position that does not overlap the microfluidic chip 410. Meanwhile the first channel-side electrode 442 is formed at a position that overlaps the first electrode opening 428 and exposes in the first space 420. The first interconnect 444 connects the first channel-side electrode 442, and the first measuring instrument-side electrode 446.

Similarly, the second electrode E2 has a second channel-side electrode 448, a second interconnect 450, and a second measuring instrument-side electrode 452. The second measuring instrument-side electrode 452 is formed at a position that does not overlap the microfluidic chip 410. Meanwhile the second channel-side electrode 448 is formed at a position that overlaps the second electrode opening 430 and exposes in the second space 422. The second interconnect 450 connects the second channel-side electrode 448, and the second measuring instrument-side electrode 452.

The first electrode E1 and the second electrode E2 are electrically connectable, respectively at their first measuring instrument-side electrode 446 and the second measuring instrument-side electrode 452, to an unillustrated measuring instrument.

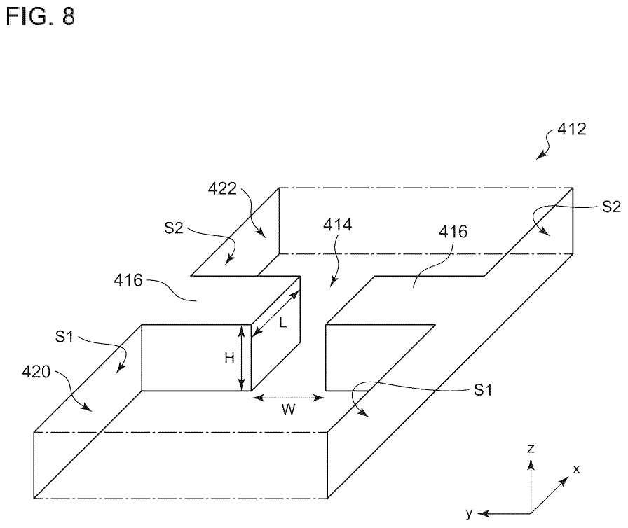

FIG. 8 is an enlarged view illustrating a gate 414 and the surrounding of the microfluidic chip 410. Side walls S1 and S2 of the microchannel 412 protrude at a part of the gate 414 towards the center, to form partition walls 416. A part positioned between the two partition walls 416 forms the gate 414 having a narrow width (length in the y-direction). At the gate 414, the microchannel 412 is partitioned into the first space 420 and the second space 422. The gate 414 is also referred to as a narrowed part. In this embodiment, the gate 414 has a rectangular cross-section defined by width W and height H.

With the length of the gate 414 denoted as L, a relational expression 1≤L/W<2 is satisfied. Similarly, a relationship of 1≤L/H<2 is satisfied. The width W and the height H may be substantially equal or different. The L/W is referred to as aspect ratio.

The structure of the microfluidic device 400 has been explained. Next, microparticle measurement with use the microfluidic device 400 will be described.

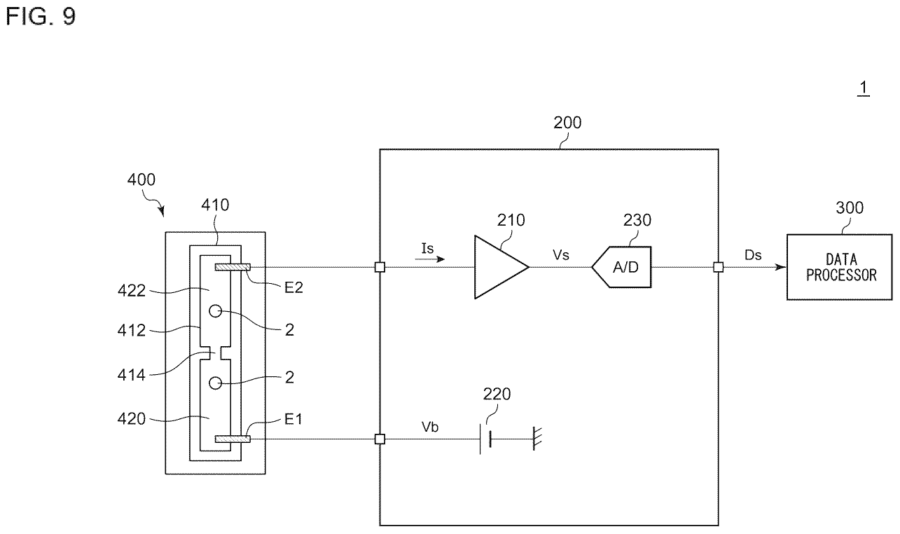

FIG. 9 is a drawing illustrating a microparticle measurement system 1 having a microfluidic device 400. The microparticle measurement system 1 has a measuring instrument 200, a data processor 300, and a microfluidic device 400.

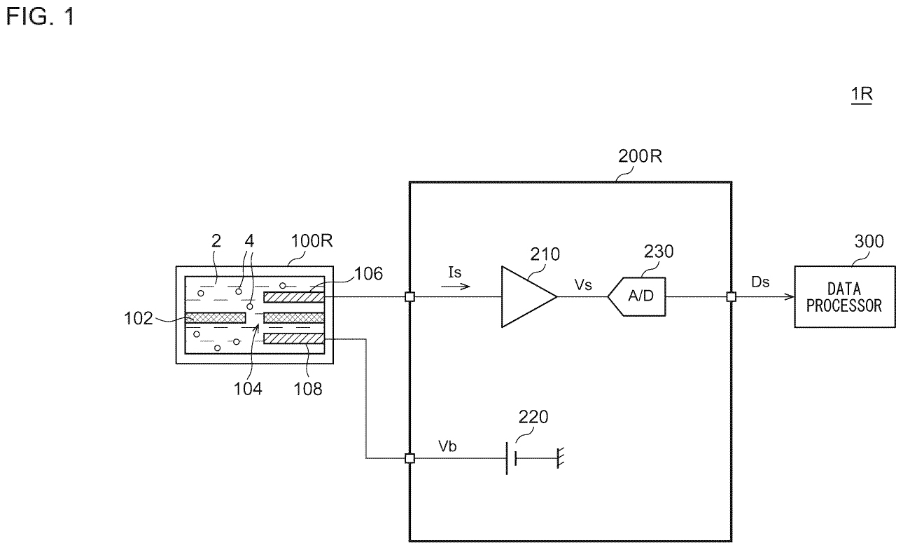

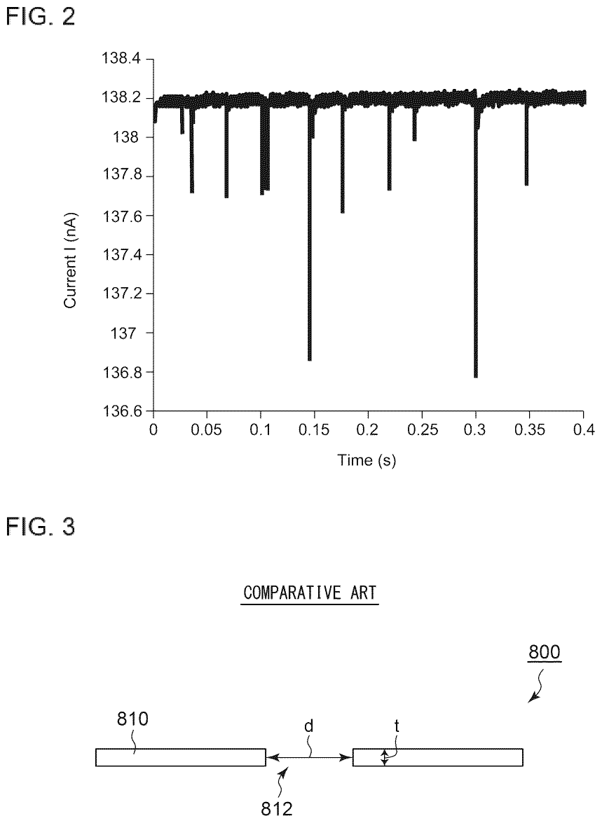

The measuring instrument 200 is structured similarly to the measuring instrument 200R in FIG. 1, and has the voltage source 220, the transimpedance amplifier 210, and the digitizer 230. The voltage source 220 applies a bias voltage Vb between the first electrode E1 and the second electrode E2 of the microfluidic device 400. The inside of the microchannel 412 of the microfluidic chip 410 is filled with an electrolytic solution that contains the microparticles 2. Under applied bias voltage Vb, current Is flows from the first electrode E1 to the second electrode E2. The transimpedance amplifier 210 converts the current Is to a voltage signal Vs. The digitizer 230 converts the voltage signal Vs to digital data Ds.

The current Is that flows from the first electrode E1 to the second electrode E2 is inversely proportional to impedance Z between the first electrode E1 and the second electrode E2. The microparticles 2 are positively or negatively charged and migrate while driven by an electric field (electrophoresis) generated between the first electrode E1 and the second electrode E2. Upon passage of the microparticles 2 through the gate 414, the impedance Z between the first electrode E1 and the second electrode E2 increases, and the current Is decreases. That is, in the microfluidic device 400, the gate 414 acts as the pore 104 in the prior pore device 100R.

In order to verify superiority of the microfluidic device 400, results of an electromagnetic field simulation will be described.

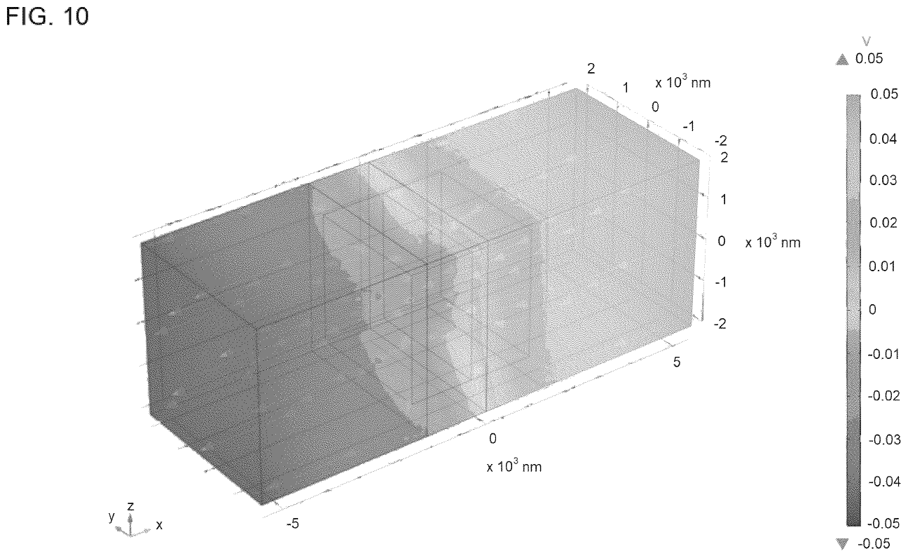

FIG. 10 is a chart illustrating potential at the gate 414 and the surrounding of the microfluidic device 400. In the simulation, sizes of the gate 414 were given by W=H=L=3 μm.

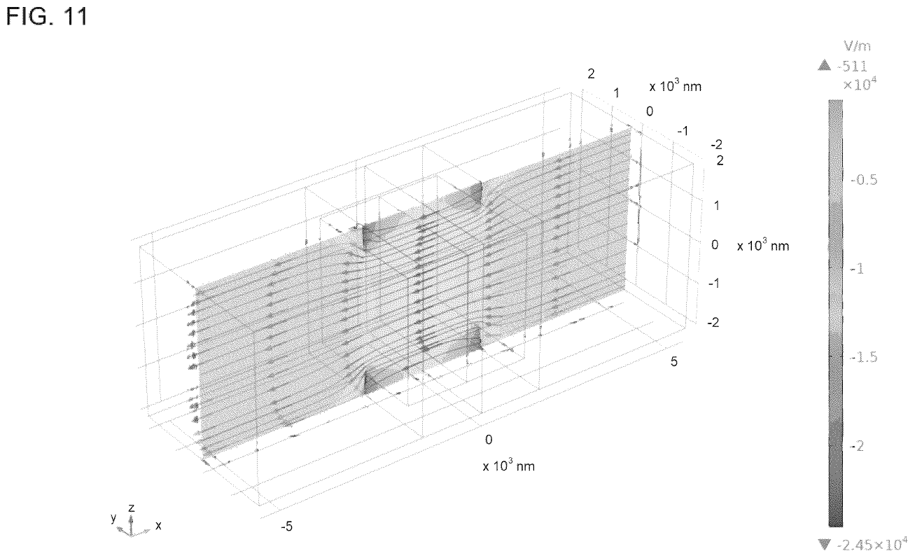

FIG. 11 is a chart illustrating an electric field at the gate 414 and the surrounding of the microfluidic device 400.

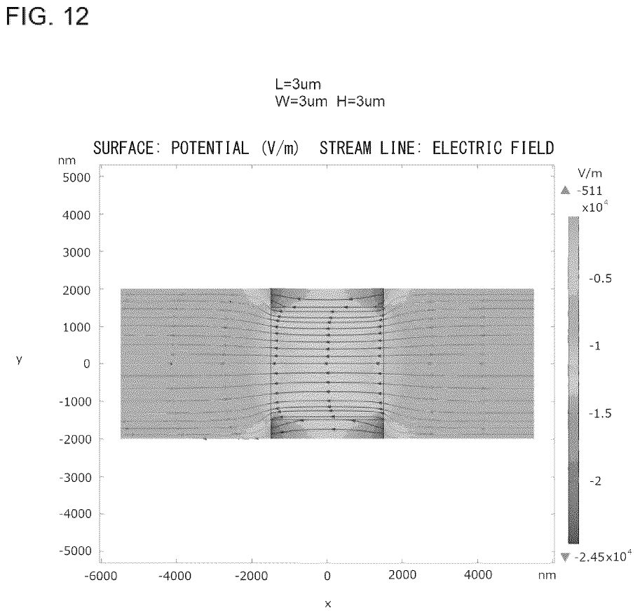

FIG. 12 is a chart illustrating an electric field distribution of a microfluidic chip 410 having sizes of W=H=L=3 μm. The abscissa represents position in the length direction (x-axis) of the microchannel 412, where x=0 represents the center of the gate 414. The ordinate represents position in the width direction (y-axis) of the microchannel 412, where y=0 represents the center of the gate 414. The gradation corresponds to the electric field intensity, and the arrows indicate the direction of the electric field.

In the device with the aspect ratio given by L/W=1, electric field vectors inside the gate 414 are found to appear in parallel without component in the direction of y-axis, demonstrating a uniform electric field distribution.

For comparison, the same simulation was conducted while setting the length L of the gate 414 to 50 nm.

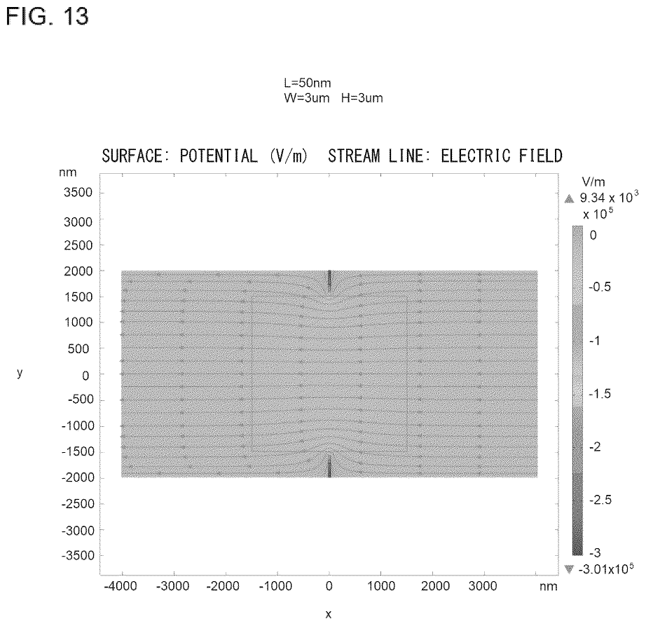

FIG. 13 is a chart illustrating an electric field distribution of a microfluidic chip 410 having sizes of W=H=3 μm, and L=50 nm. With L=50 nm, the aspect ratio L/W will be 0.017, which does not satisfy the relation of 1≤L/W<2. The electric field vectors in this case are found to have components in the direction of y-axis at the end of the gate 414, thus making the electric field distribution non-uniform.

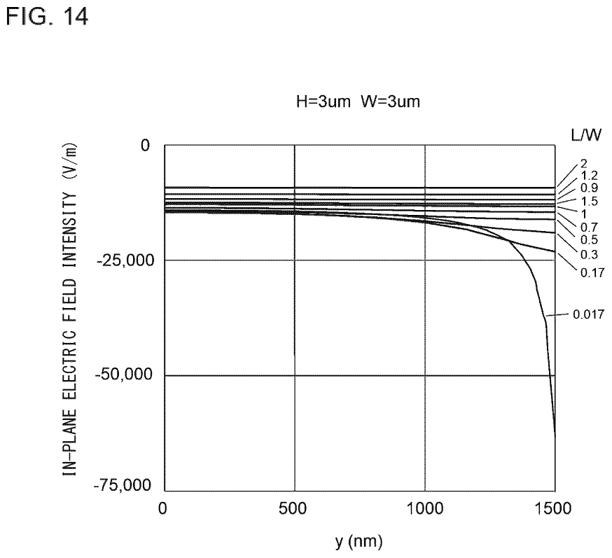

FIG. 14 is a chart illustrating aspect ratio dependence of the electric field intensity distribution in the y-direction. The abscissa represents the position in the width direction (y-axis), and the ordinate represents the electric field intensity. At lower aspect ratios L/W, the electric field intensity increases as the position gets further away from the center, or, approaches more closer to the sidewall. That is, the low-aspect-ratio device unfortunately concentrates the electric field on the end of the gate 414. In contrast, a uniform electric field intensity distribution is found to be obtainable, in a range of aspect ratio L/W of 1 or larger.

With the aspect ratio L/W controlled to 1 or larger, this embodiment can obtain a uniform electric field distribution at the gate 414. The same level of intensity of the signals will be obtainable, regardless of the route of passage of the particles. A highly unimodal histogram is therefore obtainable, while preventing the histogram from splitting. This successfully improves detection accuracy of the particle size or particle type.

With the aspect ratio L/W increased, or with the length L of the gate 414 elongated, the gate 414 will become more likely to cause clogging, and more likely to have a plurality of particles concurrently reside therein, thus degrading the measurement accuracy of the particle size distribution. Denoting now φ as the diameter of the particle, and if L<2×φ holds, then the count of the particle that can concurrently reside in the gate 414 is regarded as 1. Now the diameter φ of the particle that can pass through the gate 414 is limited by the width W of the gate 414, where a relationship of φ<W holds. Therefore, if L<2×W, that is L/W<2, then the probability that a plurality of particles can concurrently reside in the gate 414 may be reduced, whereby the measurement accuracy may be improved. Similarly, since φ<H holds, a probability that a plurality of particles can concurrently reside in the gate 414 may be reduced if a relation L<2×H, that is L/H<2 holds, whereby the measurement accuracy may be improved.

Next, a modification of the microfluidic device 400 of First Embodiment will be explained.

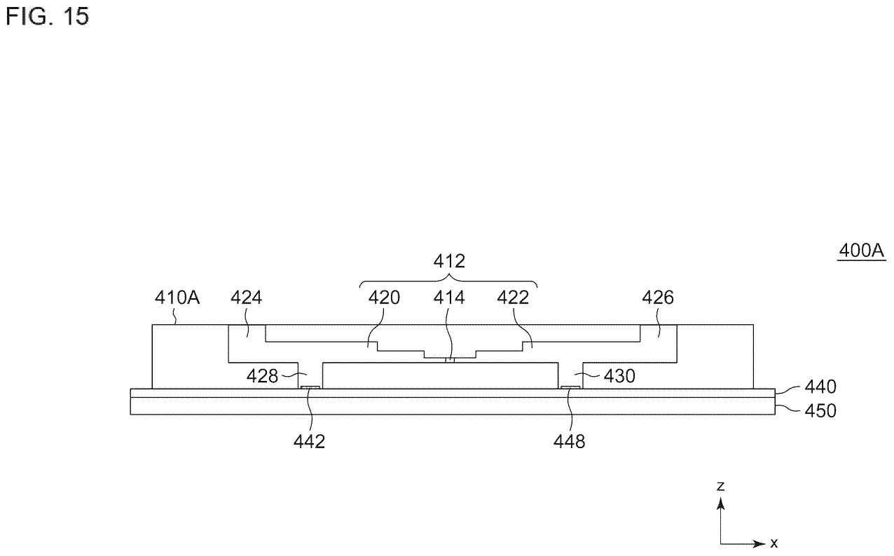

FIG. 15 is a cross-sectional view illustrating a microfluidic device 400A of Modified Example 1. In this modified example, the height of the first space 420 and the second space 422 decreases stepwise towards the gate 414. With this, the first space 420 and the second space 422 may be more easily filled with the electrolytic solution that contains the particles. Also, the particles may more easily reach the gate 414 during the measurement.

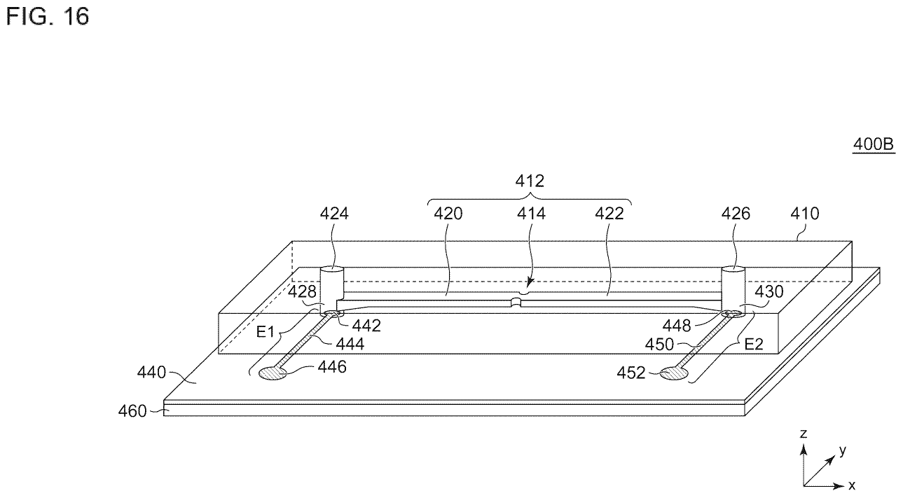

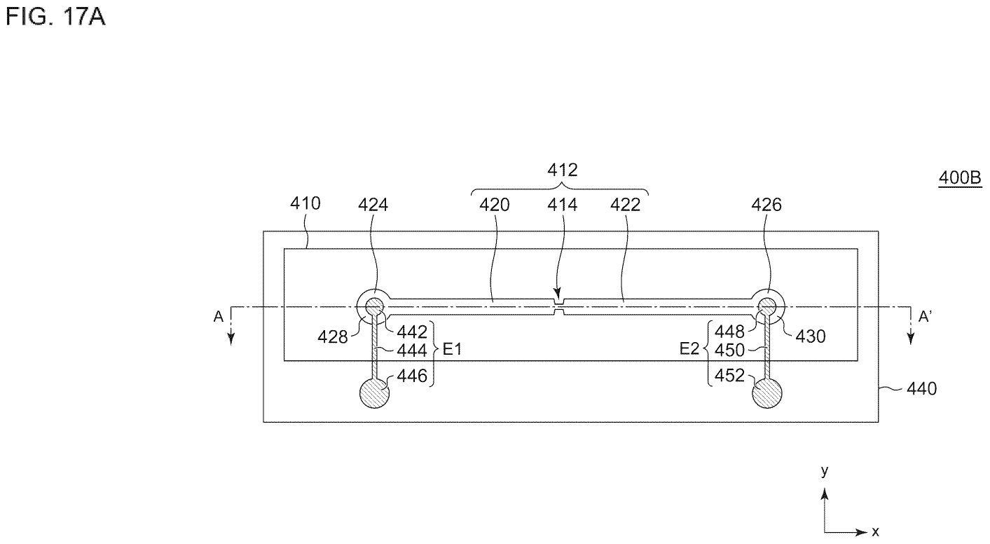

FIG. 16 is a perspective view illustrating a microfluidic device 400B of Modified Example 2. FIG. 17A is a plan view illustrating the microfluidic device 400B in FIG. 16. FIG. 17B is a cross-sectional view of the microfluidic device 400B in FIG. 17A, taken along line A-A′. In this modified example, the first electrode opening 428 is provided at the same position as the inlet 424, and the second electrode opening 430 is provided at the same position as the outlet 426.

The height of the first space 420 and the second space 422 decreases continuously and gradually towards the gate 414.

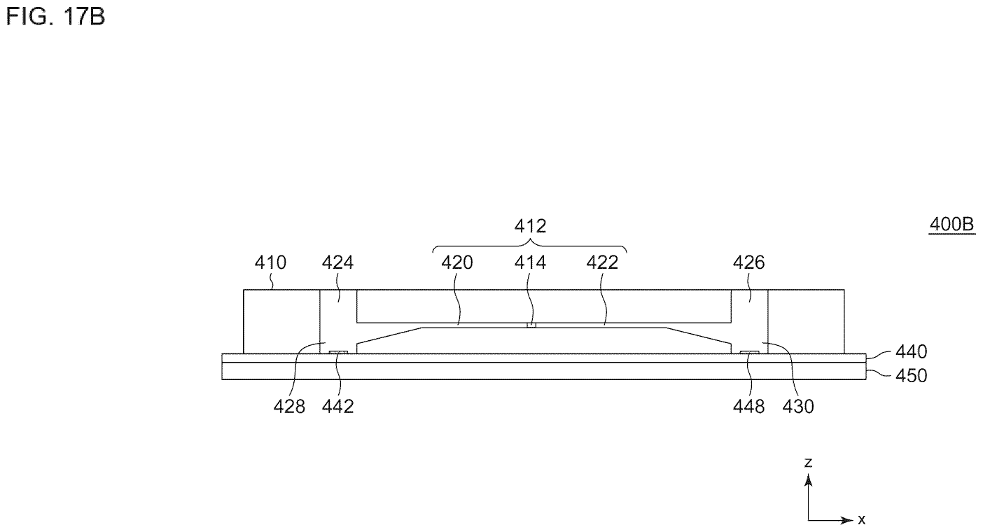

FIG. 18 is an enlarged view illustrating the gate 414 and the surrounding of a microfluidic chip 410C of Modified Example 3. In this modification, the shape of partition walls 416C is different from that of the partition walls 416 in FIG. 8. More specifically, the partition walls 416C are formed so as to continuously narrow the width of the first space 420 and the second space 422 towards the gate 414.

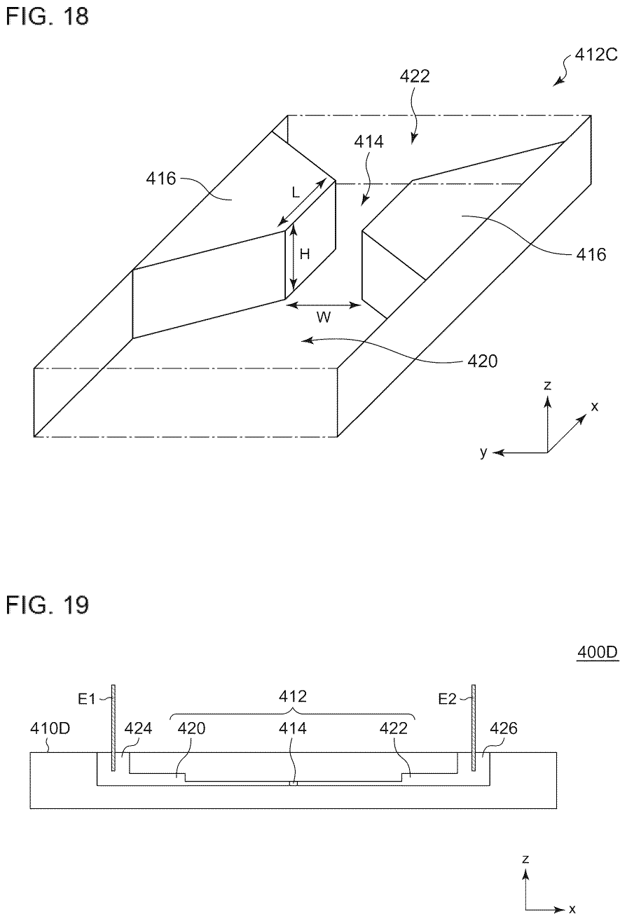

FIG. 19 is a cross-sectional view illustrating a microfluidic device 400D of Modified Example 4. The microfluidic device 400D lacks the electrode sheet 440. The microfluidic chip 410D also lacks the first electrode opening 428 and the second electrode opening 430. The inlet 424 and the outlet 426 are structured to accommodate rod-like first electrode E1 and second electrode E2 inserted therein.

In the microfluidic device 400 described in First Embodiment, the first space 420, the gate 414, and the second space 422 can be filled with the liquid by injection through the inlet 424, if the width W (and/or height H) of the gate 414 is up to several micrometers (3 μm, for example). The liquid injected through the inlet 424 will, however, be less likely to enter the gate 414 having a width W narrower than 3 μm.

The paragraphs below will describe Second Embodiment, regarding a microfluidic device with a small cross-sectional area of the gate 414, suited to detection of further smaller microparticles.

### Second Embodiment

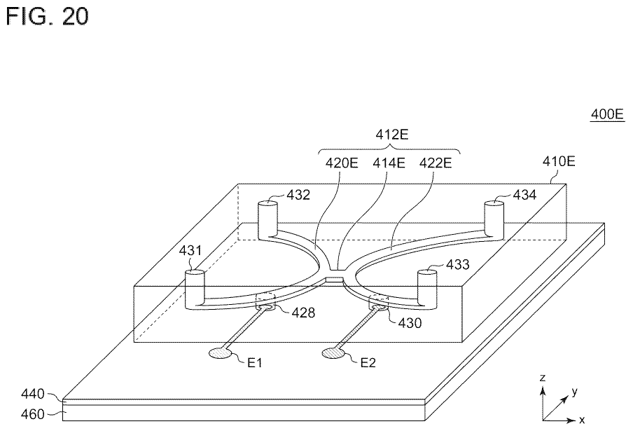

FIG. 20 is a plan view illustrating a microfluidic device 400E of Second Embodiment. In Second Embodiment, each of a first space 420E and a second space 422E has a U-shape. The first space 420E and the second space 422E may alternatively have a V-shape, a J-shape, or a horseshoe shape, without special limitation.

On the side of the first space 420E, there are provided a first inlet 431 and a first outlet 432. The first inlet 431 communicates one end of the first space 420E with the upper face of the microfluidic chip 410E. The first outlet 432 communicates the other end of the first space 420E with the upper face of the microfluidic chip 410E.

Similarly, on the side of the second space 422E, there are provided a second inlet 433 and a second outlet 434. The second inlet 433 communicates one end of the second space 422E with the upper face of the microfluidic chip 410E. The second outlet 434 communicates the other end of the second space 422E with the upper face of the microfluidic chip 410E.

The first space 420E and the second space 422E are connected while placing a gate 414E in between.

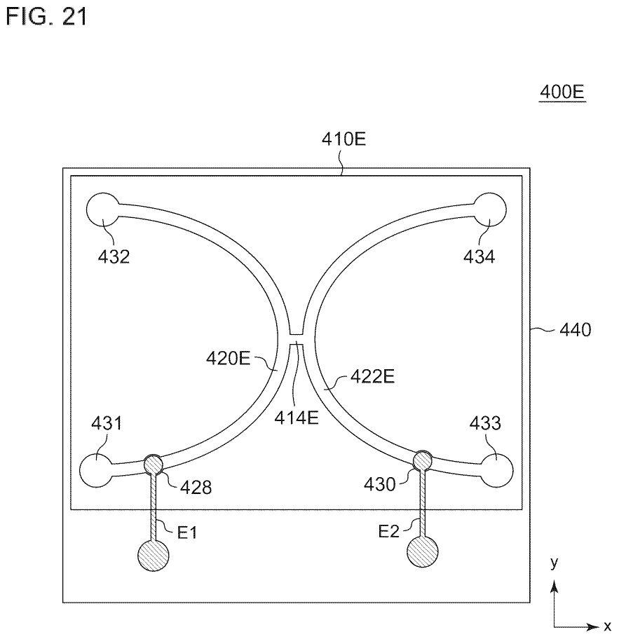

FIG. 21 is a plan view illustrating the microfluidic device 400E in FIG. 20.

Prior to the measurement, the liquid is injected through the first inlet 431 into the first space 420E, so as to fill the inside thereof from the first inlet 431 towards the first outlet 432. Similarly, the liquid is injected through the second inlet 433 into the second space 422E, so as to fill the inside thereof from the second inlet 433 towards the second outlet 434. Upon arrival of the liquid in the first space 420E and the second space 422E at the gate 414E, also the gate 414E is filled with the liquid by capillarity.

Also in Second Embodiment, the internal heights of the first space 420E and the second space 422E may be gradated stepwise.

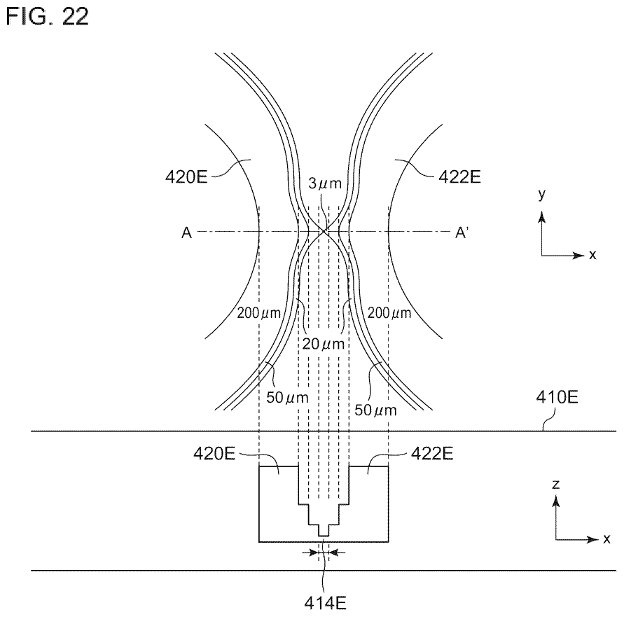

FIG. 22 contains a plan view illustrating the microfluidic device 400E in FIG. 21, and a cross-sectional view taken along line A-A′. The height of each of the first space 420E and the second space 422E is higher on the inner periphery of the U-shape, and becomes lower towards the outer periphery, that is, towards the gate 414E. For example, the first space 420E and the second space 422E are 1 mm wide, with the depth gradated in three steps of 200 μm, 50 μm, and 20 μm. The gate 414E is approximately 3 μm high.

The modification described in First Embodiment can also be applied to Second Embodiment. For example, Second Embodiment may lack the first electrode opening 428 and the second electrode opening 430 and may instead have the rod-shaped first electrode E1 and second electrode E2 inserted into the first inlet 431 and the second inlet 433, respectively.

Having described the present disclosure with use of specific terms referring to the embodiments, the embodiments merely illustrate the principle and applications of the present disclosure, allowing a variety of modifications and layout change without departing from the spirit of the present disclosure specified by the claims.

What is claimed is:

1. A microfluidic device comprising a microfluidic chip,
the microfluidic chip having a channel formed in an in-plane direction thereof,
the channel having a gate with a narrowed width, and a first part and a second part separated by the gate, and with a length of the gate denoted as L, and with a width of the gate denoted as W, a relational expression 1≤L/W<2 being satisfied.

2. The microfluidic device according to claim 1, wherein a cross-section of the gate has a rectangular shape.

3. The microfluidic device according to claim 2, wherein the cross-section of the gate has a width and a length which are substantially equal.

4. The microfluidic device according to claim 1, wherein the microfluidic chip is formed of polydimethylsiloxane.

5. The microfluidic device according to claim 1, wherein the microfluidic chip has:
an inflow port structured to communicate the outside of the microfluidic chip with the first part; and
an outflow port structured to communicate the outside of the microfluidic chip with the second part.

6. The microfluidic device according to claim 1, wherein the microfluidic chip includes:
a first inflow port structured to communicate the outside of the microfluidic chip with the first part;
a second inflow port structured to communicate the outside of the microfluidic chip with the second part;
a first outflow port structured to communicate the outside of the microfluidic chip with the first part; and
a second outflow port structured to communicate the outside of the microfluidic chip with the second part.

7. The microfluidic device according to claim 1, wherein the microfluidic chip further has:
a first electrode opening structured to communicate a bottom face of the microfluidic chip with the first part; and
a second electrode opening structured to communicate a bottom face of the microfluidic chip with the second part,
the microfluidic device further comprises an electrode sheet having the microfluidic chip stacked on a surface thereof, and
the electrode sheet has, formed on a surface thereof, a first electrode drawn out through the first electrode opening, and a second electrode drawn out through the second electrode opening.

8. A microparticle measurement system comprising:
the microfluidic device according to claim 1; and
a measuring instrument connected to the microfluidic device and structured to measure an electric signal.
